(19) United States
(12) Patent Application Publication
(10) Pub. No.: US 2004/0225582 A1
(43) Pub. Date: Nov. 11, 2004

(54) System and method for prepaid roadside assistance

(76) Inventor: Gil Spitzer, Cooper City, FL (US)

Correspondence Address: OSTROLENK FABER GERB & SOFFEN, 1180 AVENUE OF THE AMERICAS, NEW YORK, NY, 100368403

(21) Appl. No.: 10/428,462

(22) Filed: May 2, 2003

(51) Int. Cl. G06F 17/60

(52) U.S. Cl. 705/35

(57) ABSTRACT

A system and method for providing prepaid roadside assistance service is disclosed in which annual membership fees are not required. Instead of prior art auto clubs and other membership arrangements, the invention provides for prepaid roadside assistance service agreement cards to be sold. The cards identify one or more specific roadside assistance service(s) that is/are provided for purchaser or cardholder. The service(s) described in the card are available for a period of time, typically three years from distribution in retail stores, after which the cards expire.

### FIELD OF THE INVENTION

The present invention relates to a system and method for providing automotive services, and, more particularly, for providing prepaid roadside assistance to motorists.

### BACKGROUND OF THE INVENTION

Prepaid roadside assistance service provides motorists with an assurance that in the event of a roadside problem, such as a flat tire, overheated engine or other event causing a vehicle to stop running, roadside assistance will be rendered to the motorist.

Typically, such prepaid roadside assistance service is provided by an automobile club that charges an annual membership fee to the motorist. The benefits of membership typically include a predetermined number of roadside assistance service calls, such as vehicle tows by a tow truck, and further include other services, for example, discounts on travel services, free maps and directions, and even guaranteed posting of bail bonds. Membership in an auto club, typically, must be renewed by paying an additional membership fee for each additional year of service. Alternatively, car dealerships offer roadside assistance programs for vehicles that are leased or purchased. In such case, a membership fee is also charged and, as in the automobile club scenario, membership lasts for one year. Some dealerships include the costs associated with prepaid roadside assistance service in the total lease or purchase price of a vehicle. In such case, vehicle lease purchasers pay for prepaid roadside assistance service whether they elect to use the service or not.

As used herein, the term “roadside assistance service” refers generally to automotive service that is provided outside of a professional automotive service garage. For example, a battery jump start that is provided in a parking lot for an automobile that has a run-down battery is considered herein to be roadside assistance service. Other examples of roadside assistance service include filling a vehicle's fluid (e.g., gasoline, oil, radiator fluid and the like), changing a tire, opening a locked vehicle, towing a vehicle to a professional automobile service garage and the like.

Referring now to the drawings figures in which like reference numerals refer to like elements, there is shown in FIG. 1 a diagram of an example prior art arrangement of parties to prepaid roadside assistance service. As shown in FIG. 1, a motor club 10 contracts with motorists to provide roadside assistance service to members 12 on a membership fee basis. For example, the motor club 10 receives annual fees from members 12, and provides subcontracted roadside assistance service during the single year that corresponds with the annual membership fee. In spite of annual membership fees, additional fees for roadside assistance services are typically incurred by members 12, such as for tows that exceed a maximum mileage, or for requesting a number of service calls over the course of a year that exceeds a preset number identified in the membership agreement between the motor club 10 and the member 12.

In the typical prior art prepaid roadside assistance service arrangement, roadside assistance service subcontractors 14 contract with a motor club 10 to provide many of the services guaranteed by the motor club. For example, three roadside assistance service subcontractors 14 that provide towing services are hired by the motor club 10 to do all of the towing for the motor club's members within a geographic region.

The motor club 10 typically negotiates a rate with the subcontractors 14 for services that is significantly less than what the market would otherwise bear. For example, the market rate for changing a tire on a roadside is $50.00. The motor club 10, however, pays its subcontractor towing companies 14 $9-$13 for each tire change service. To compensate for the low rates, the motor club 10 promises access to a large market share and uses the access as a bargaining leverage. Believing they will make up for the losses in volume, the subcontractors 14 agree to the terms. However, because of the low rates received, the subcontractors 14 have little to no incentive to arrive quickly at a roadside call, nor to provide high quality service once they arrive. As a result, motorists belonging to a motor club are assigned the lowest priority by subcontractors 14 and are forced to wait a long time for help to arrive on the scene.

Furthermore, most subcontractors 14, such as those who provide towing services, do not dedicate a substantial portion of their businesses to the specific service they subcontract with the motor club 10. For example, most subcontractors 14 who provide towing services for a motor club 10 operate automotive repair facilities as their primary businesses, and each have two or three tow trucks which they use for their subcontracting services with the motor club 10. Most towing companies participating with the motor clubs provide limited free towing, for example, up to three miles, and charge for each mile thereafter. However, these same companies provide unlimited towing to their own garages. Also, most motor clubs contract with the lowest bidder in the area. As a result, the towing company often lacks the capital to maintain their fleet and hire professional, licensed drivers. In addition, the driver of the tow truck is often pressured to convince the motorist to pay for unnecessary repairs.

The subcontractors 14 typically will not recoup the costs associated with maintaining the two or three tow trucks and the personnel needed to operate the trucks. Therefore, subcontractors 14 typically only break even, or even lose money on their contracts with a motor club 10.

Additionally, subcontractors 14 that provide roadside assistance service in the prior art do not achieve formal recognition, for example, with respect to their business or trade names. Subscribing members 12 to a motor club 10 typically only see the name of the subcontractor 14 that provides roadside assistance service at the time the service is actually provided. All printed matter regarding the members' agreement and relationship with the motor club 10, such as identification cards and stickers, only identifies the motor club 10. As a result, sub-contractors 14 do not receive any advertising benefits, for example, prior to providing roadside assistance service.

Thus, for members 12 and subcontractors 14 alike, prior art roadside assistance has certain drawbacks. Members 12 frequently must wait a significant amount of time before receiving roadside assistance service which, unfortunately, is frequently provided in a substandard way. Moreover, subcontractors 14 are not well compensated by a motor club 10 for the services they provide, and, further, they do not receive adequate recognition in the market.

### SUMMARY OF THE INVENTION

A system is needed that ensures prepaid roadside assistance service will be provided without the requirement of membership. Furthermore, a need exists for prepaid roadside assistance plans that do not expire at the end of a single year.

The present invention provides an improved system and method for providing prepaid roadside assistance service. More particularly, information regarding at least one prepaid agreement for roadside assistance service is stored, for example, in a computer. Further, information regarding at least one roadside assistance service and at least one subcontractor who provides roadside assistance service is also stored. Information regarding the subcontractor(s) is used to identify at least one subcontractor for providing roadside assistance service in the prepaid roadside assistance service agreement.

Moreover, the present invention makes available for sale prepaid roadside assistance for at least one specific roadside assistance service for a predetermined period of time. For example, a motorist is offered for sale a single, prepaid tow in the event that motorist's vehicle should require a tow within three years from the date of distribution.

The present invention further provides one or more additional services to the one or more prepaid roadside assistance service available for purchase.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows a block diagram illustrating a prior art arrangement of parties with respect to automotive roadside assistance;

FIG. 2 illustrates a block diagram of arrangements of parties with respect to automotive roadside assistance in accordance with the present invention;

FIG. 3 is a block diagram showing a site processor and sources of information that are electronically stored thereon;

FIG. 4 is a block diagram that illustrates components that are included in an example prepaid roadside assistance service card in accordance with the present invention; and

FIG. 5 shows a flow chart that identifies use of the present invention.

### DETAILED DESCRIPTION OF PREFERRED EMBODIMENTS OF THE INVENTION

The present invention provides a system and method for providing prepaid automotive roadside assistance without the requirement of annual membership. Further, a fee is paid for a corresponding amount of roadside assistance service that is available for use within a period of time, for example, within three years. Preferably, the period of time that is available for using the roadside assistance service in accordance with the present invention is longer than that provided for in prior art roadside membership agreements, which typically last only for a single year.

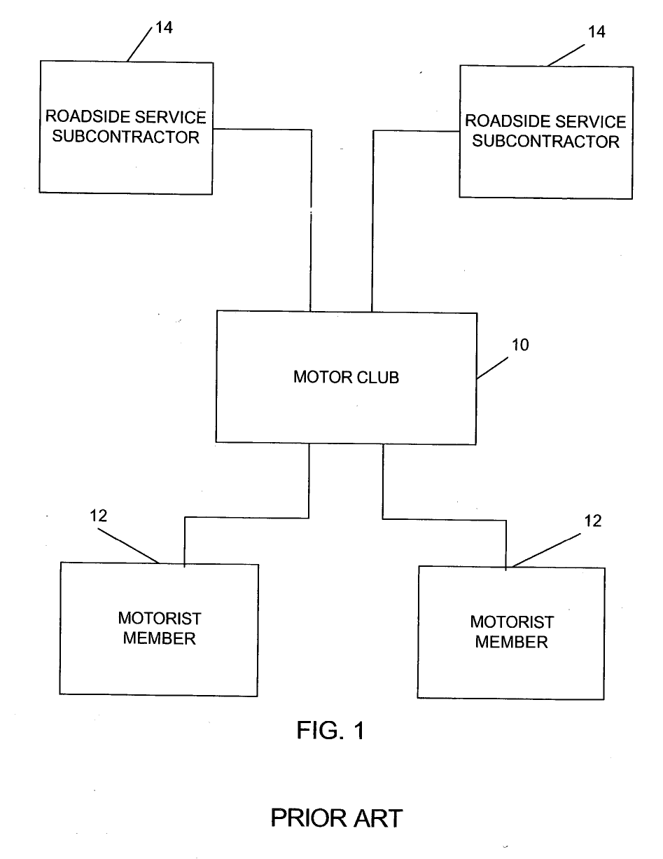

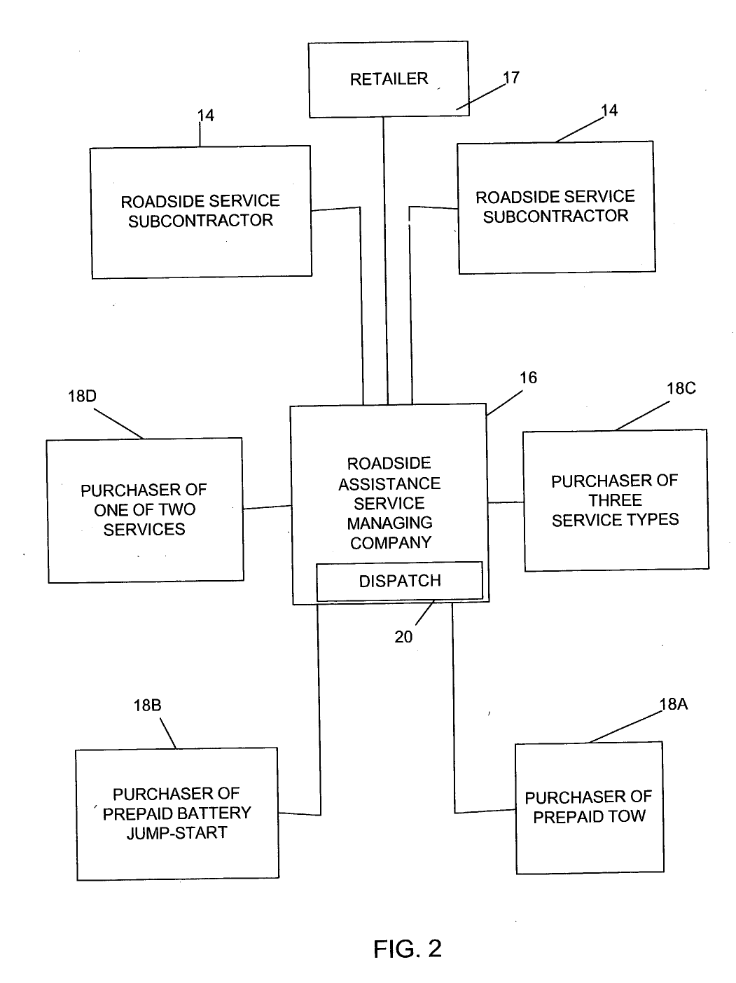

FIG. 2 shows an example arrangement of parties with respect to automotive prepaid roadside assistance in accordance with the present invention. As shown in FIG. 2, a prepaid roadside service managing company 16 has replaced the auto club 10 (FIG. 1) and preferably manages many of the processes described herein. For example, the prepaid roadside service managing company 16 contracts with roadside service subcontractors 14 to ensure that timely and quality roadside assistance services are provided to purchasers of prepaid roadside assistance service. Also shown in FIG. 2, Retailer 17 is included as a party who sells prepaid roadside assistance agreements to consumers. In place of motorists members 12 (FIG. 1), purchasers of prepaid roadside assistance service 18 contract with the roadside service managing company 16. Further, dispatcher 20 works with the roadside service managing company 16 to dispatch roadside service subcontractors 14.

Unlike prior art motor club arrangements, each purchaser of prepaid roadside assistance service 18 purchases one or more specific roadside assistance services. In the example shown in FIG. 2, purchaser 1 8A has purchased the right to a single towing service, and purchaser 1 8B has purchased the right to a single battery jump-start. Moreover and as shown in FIG. 2, purchaser 18C has purchased the right to three roadside assistance services, and purchaser 1 8D has purchased one roadside assistance service, but is entitled to pick from three alternatives. For example, purchaser 1 8D is entitled to one roadside assistance service comprising a tow, a battery jump-start and a fluid refill. Such flexibility is both attractive and economically beneficial for purchasers 18. Rather than purchasing a year's membership from an auto club 10 and never using the benefits of membership, for example because no roadside assistance service is required during the membership year, purchasers 18 can use just the service they need, at a time when they need it.

As used herein, the term “purchaser” refers to a person who has purchased a prepaid roadside assistance service agreement that identifies roadside assistance services in accordance herein. Also as used herein, the term “purchaser” refers to a person who is lawfully in possession of a prepaid roadside assistance service agreement, such as a person who obtained the agreement by gift or other means. Also as used herein, the term “cardholder” refers to a person who is in possession of a prepaid roadside assistance service agreement, even though that person may have obtained the agreement by gift or other lawful means. Effectively, the terms, “cardholder” and “purchaser,” are used synonymously. Moreover, the terms “purchaser” and “cardholder” do not necessarily imply a sale, but, instead refer to anyone who is in possession of a prepaid roadside assistance service agreement and is legally entitled to the roadside assistance service(s) described therein.

In a preferred embodiment of the present invention, a plurality of computer-related applications preferably receives, process and transmit information that comprises roadside service subcontractors, prepaid service agreements, street locations (e.g., mapping and GPS technology) and roadside assistance services. Based on variables such as vehicle location, the problem with the vehicle and/or the service requested, the computer-related applications are used to ensure that a roadside service subcontractor 14 who is in close proximity to the purchaser 18, who has an exemplary performance record and is well-equipped to provide the roadside assistance service being requested is promptly dispatched. For example, the dispatcher 20 (FIG. 2) uses the information provided by the computer-related applications to contact the appropriate roadside service subcontractor 14 and provide the necessary roadside assistance services.

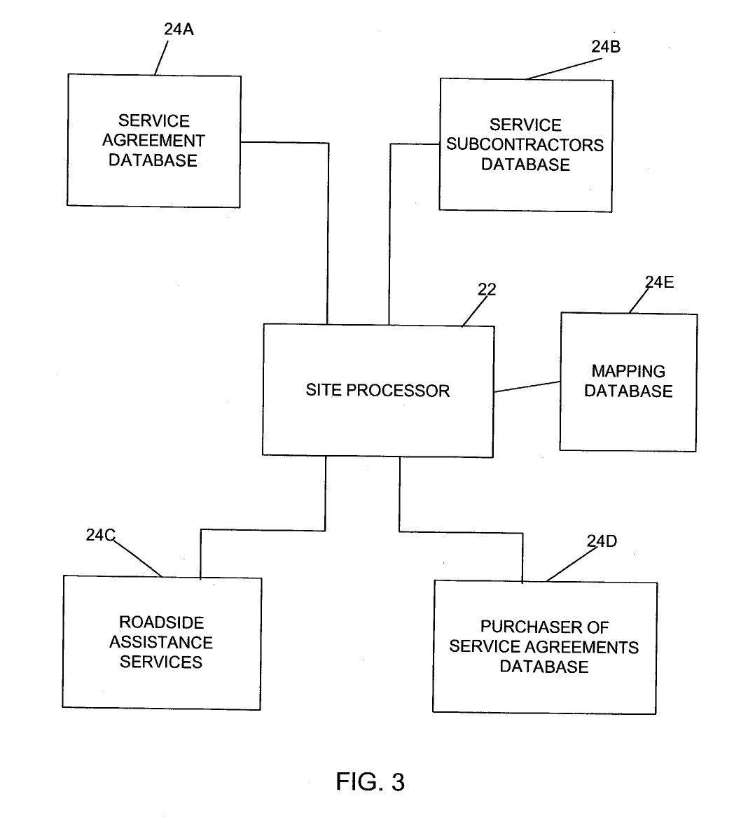

FIG. 3 shows an example arrangement including at least one site processor 22 and a plurality of databases constructed in accordance with the present invention. Site processor 4 preferably includes all necessary databases for the present invention. However, it is contemplated that site processor 4 can access any required databases via a communication network, such as the Internet or any other communication network, to which site processor 4 has access. Site processor 4 can communicate devices comprising databases using any known communication method, including, for example a direct serial or parallel interface, or via a local wide area network.

Work stations communicate with site processors using data connections, which are respectively coupled to a communication network. The communication network can be any communication network, but is typically the Internet or some other global computer network. Data connections can be any known arrangement for accessing communication network, such as dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

Moreover, the work stations preferably have the ability to send and receive data across communication network, and are equipped with web browsers to display the received data on display devices incorporated therewith. By way of example, a work station may be personal computers such as Intel Pentium-class computers or Apple Macintosh computers, but are not limited to such computers. Other terminals which can communicate over a global computer network such as palmtop computers, personal digital assistants (PDAs) can be used. In addition, the hardware arrangement of the present invention is not limited to devices which are physically wired to the communication network. It is contemplated that wireless devices using a wireless application protocol (WAP) can interoperate with site processors 4 using wireless data communication connections.

FIG. 3 illustrates an example of some of the databases 24 that comprise the present invention. A plurality of databases is shown to illustrate the types of information included in the present invention. Of course, one skilled in the art will recognize that, alternatively, only one database can be fashioned to include all of the categories of information shown in FIG. 3. For purposes of illustration, however, a plurality of databases is described, with each database representing a specific category of information.

In the example shown in FIG. 3, a plurality of databases 24 is shown. For example, a prepaid roadside assistance service agreement database 24A is included that comprises information regarding roadside assistance service agreements that are either being prepared or are in circulation. Further, a roadside assistance service subcontractor database 24B is shown that preferably comprises information relating to subcontractors 14 who provide roadside assistance service in accordance with the present invention. Further, a roadside assistance services database 24C is shown which comprises information directed to the services that can be offered by subcontractors 14. Additionally, a party to agreement database 24D is maintained that comprises information regarding purchasers 18 (FIG. 2) and the respective services they have used in connection with the present invention.

Further to FIG. 3, a mapping database 24E is included which preferably includes mapping technology for locating vehicles and subcontractors 14, or for providing directions therefor. In a preferred embodiment of the present invention, satellite technology, such as Global Positioning Systems and the like are used to help locate and direct the participants of the present invention. By using the databases described herein, a dispatcher 20 uses the present invention, for example, to cross-reference a roadside assistance service need with one or more appropriate subcontractor(s) 14, and further to locate the closest subcontractor 14 to the party in need.

In a preferred embodiment, prepaid roadside assistance agreements are sold as cards in retail stores and provide for one or more roadside assistance service. For example, a card is available for sale that identifies a single prepaid roadside assistance service, a fluid refill. The fluid refill is available as a roadside assistance service to the purchaser one time only and within a predetermined period, for example, three years from the date of distribution of the card. For example, when a purchaser requires a fluid refill as a roadside assistance service, he contacts the provider listed on the card and help is dispatched. In a preferred embodiment, the cards can be given away or resold.

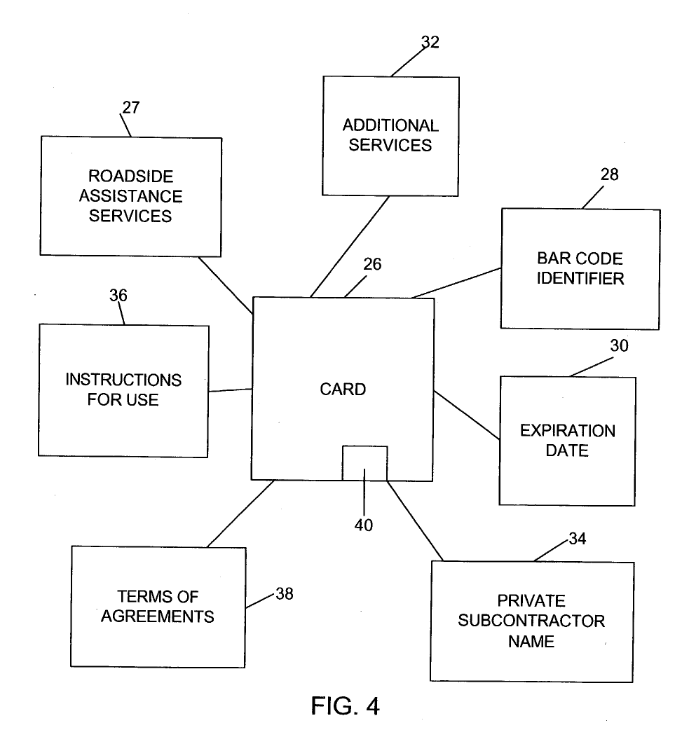

FIG. 4 shows components that comprise a prepaid roadside assistance service agreement, preferably formatted as a card 26. A plurality of types of information is listed in different components on the prepaid roadside assistance service card 26. For example, and shown in FIG. 4, the roadside assistance services component 27 includes an account number and description that identifies to the cardholder the respective roadside assistance service(s) to which the card 26 pertains. In a preferred embodiment, roadside assistance services component 27 is color coded such that one who is viewing the card can quickly identify the services that are available. For example, a battery jump start is colored red, a fluid refill is colored purple, a car door unlocking service is colored blue, a tow is colored green and a tire change is colored black. Of course, many different colors and colored combinations are envisioned herein to represent individual roadside assistance services, and combinations thereof.

Further, and shown in FIG. 4, a bar code 28 is preferably printed on the card 26 that represents the card 26 and prepaid roadside assistance service(s) that is/are available to the holder. In a preferred embodiment of the present invention, the bar code is read by a bar code reading device and the information in the bar code is referenced by the prepaid roadside assistance service agreement database 24A (FIG. 3). Once the bar code information is extracted, much more information directed to the card 26, for example, the location where the card 26 was sold, the price of the card 26, additional services that are available to the cardholder and the like can be retrieved and used in accordance herewith.

Another component of the prepaid roadside assistance service agreement card 26, and shown in FIG. 4, includes the expiration date 30 that identifies when the terms of the card 26 are set to expire. Further, an additional services component 32 is included that identifies services available to the purchaser 18 beyond roadside assistance services. For example, the prepaid roadside assistance service agreement card 26 provides for directions to an automatic teller machine, a gas station, and other directions requested by the purchaser 18. Further, the card 26 preferably provides for relaying messages to third parties, hotel and vehicle rental discounts, hotel and vehicle reservations, personalized trip planning, accident repair assistance, new and used car purchasing services, and a personal mechanic hotline for providing professional mechanic advice to the purchaser 18.

Moreover, the prepaid roadside assistance service agreement card 26 preferably includes an identifying component 34 that identifies the name of a private subcontractor 14 who provides roadside assistance service in accordance with at least one service identified on the card. By showing the name of a subcontractor 14, the present invention effectively provides advertising and exposure for participating subcontractors 14. Unlike prior art auto clubs 10 wherein subcontractors 14 operate in relative obscurity, the present invention serves to increase exposure for its participants.

Furthermore, the prepaid roadside assistance service agreement card 26 includes an instructions component 36 that serves to inform the purchaser 18 on how to gain access to the services provided therein. Additionally, a terms of agreement component 38 is preferably provided that includes language identifying legal disclaimers, limitations of liability and rights the cardholder has.

In a preferred embodiment of the present invention, the prepaid roadside assistance service agreement card 26 has a perforated portion 40 and is removable by the cardholder. Such a design is useful because a small portion of the card 26 is preferably detachable and can be stored in a convenient place, such as a sleeve in a wallet. The cardholder can carry with him a small and convenient representation of the prepaid roadside assistance service agreement that is used to redeem the services identified therein.

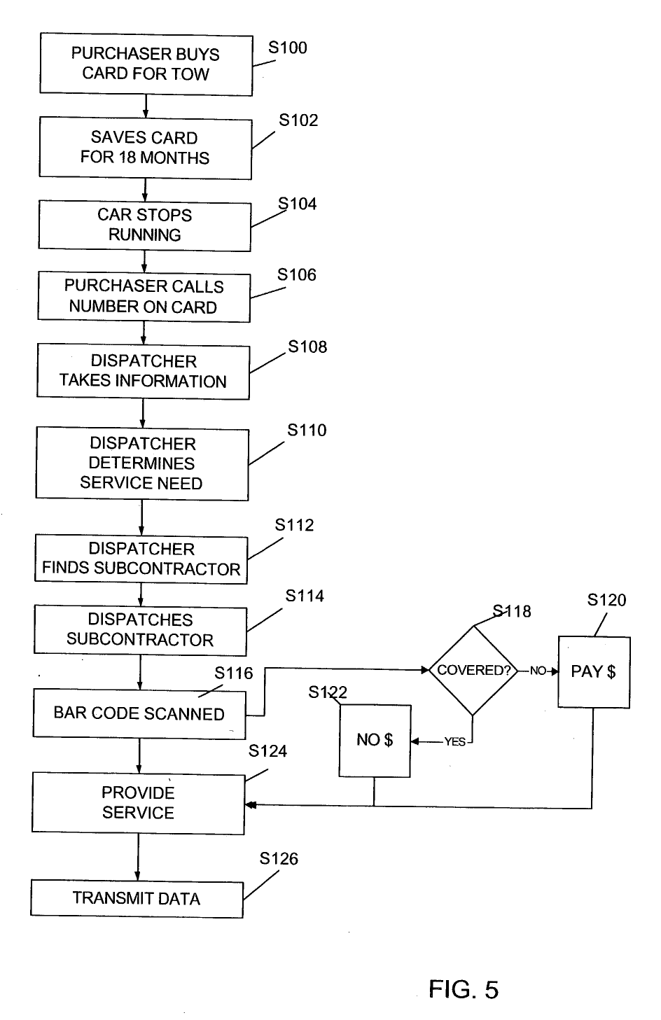

Additional functionality provided by the present invention is provided below with reference to the flow chart shown in FIG. 5.

FIG. 5 shows a flow chart that identifies steps associated with an example prepaid roadside assistance service received in accordance with the present invention. A shown in FIG. 5, a purchaser 18 purchases a prepaid roadside assistance service agreement card 26 that is provides a single tow and is to expire within 30 months from the date of purchase (step S100). The purchaser 18 tears the perforated portion 40 from the card 26 and stores the portion 40 in her wallet for 18 months (step S102).

Continuing with the example in FIG. 5, after 18 months, the purchaser's car fails to start in a parking lot at a shopping mall (step S104). In step S106, the purchaser 18 retrieves the perforated portion 40 from her wallet and calls the telephone number on the back of the card 26. In a preferred embodiment of the present invention, the telephone number provided on the card 26 is a toll free number. A dispatcher 20 answers the telephone and proceeds to take information from the purchaser 18 (step S108). For example, the dispatcher 20 receives the location of the vehicle, vehicle information (e.g., year, make, model, color and license plate number), the account number that is printed on the card and the service to which the purchaser 18 is entitled. In addition, in step S108, the dispatcher 20 assesses the type of service that the purchaser 18 requires (step S110). In this example, the purchaser 18 cannot start her car in a store parking lot and the dispatcher 20 determines that the purchaser 18 is in need of a tow. A cross-references is made with the roadside assistance service subcontractor database 24B, and the dispatcher 20 locates the closest and most appropriate subcontractor 14 to provide roadside assistance service (step S112).

Continuing with the example in FIG. 5, in step S114, the dispatcher dispatches a subcontractor 14 who arrives on the roadside scene. The subcontractor 14 preferably uses a bar code reading device and reads the bar code printed on perforated portion 40 to determine the terms in the card (step S116). A determination is preferably made, in step S118, whether the roadside assistance services required by the purchaser 18 correspond with the services entitled by the prepaid roadside assistance service agreement. In the event that the purchaser 18 is not covered for the tow (i.e., the card regards a different type of roadside assistance service), then the purchaser 18 will have to pay for the tow (step S120). However and as noted above, even in such case, the dispatcher 20 directs the purchaser 18 to the nearest automatic teller machine that is located by the disabled vehicle, as this is an additional service provided by her card. In the event that the purchaser 18 is covered for the tow, then the purchaser 18 will only pay additional fees in the event the distance of the tow exceeds that allowed under the terms of the prepaid roadside assistance service agreement (step S122). The vehicle is towed to an appropriate location (step S124). Thereafter, the subcontractor 14, in this case the tow truck company, transmits information to the site processor 4 including, for example, the final disposition of the vehicle, whether any additional monies were owed or paid, whether additional roadside assistance services were provided, and the like (step S126). In this way, the databases comprising the present invention are preferably updated with current information and the quality of service and predictability is improved with each prepaid roadside assistance service call.

Thus, the present invention meets the industry's needs in a unique and specialized way. Both purchasers of prepaid roadside assistance services and providers thereof benefit by the features described herein. The present invention provides for a towing dispatch service that is easy to access and immediately connects the motorist to a reliable towing company, anywhere in the country, without the requirement of annual membership. Although the present invention has been described in relation to particular embodiments thereof, many other variations and modifications and other uses will become apparent to those skilled in the art. Therefore, the present invention is not limited by the specific disclosure.

What is claimed is:

1. A system for providing prepaid roadside assistance service, said system comprising:
a prepaid roadside assistance service agreement module, said prepaid roadside assistance service agreement module storing information regarding at least one prepaid roadside assistance service agreement, said at least one prepaid roadside assistance service agreement representing an agreement to offer one roadside assistance service at a price;
a roadside assistance service module, said roadside assistance service module comprising information regarding at least one roadside assistance service; and
a subcontractor module, said subcontractor module comprising information regarding at least one subcontractor who provides said at least one roadside assistance service, wherein said subcontractor module identifies said at least one subcontractor to provide said one roadside assistance service in said prepaid roadside assistance service agreement.

2. The system of claim 1, further comprising a mapping module, said mapping module including a database of maps regarding at least one of streets and buildings.

3. The system of claim 2, further comprising a global position system.

4. The system of claim 1, wherein said at least one prepaid roadside assistance service agreement includes an account number and description, said account number and description representing said one roadside assistance service.

5. The system of claim 4, wherein said at least one prepaid roadside assistance service agreement comprises a bar code, said bar code comprising information representing said at least one of said account number and said description.

6. The system of claim 1, wherein said at least one prepaid roadside assistance service agreement comprises a service color, said service color representing said one roadside assistance service.

7. The system of claim 1, wherein said prepaid roadside assistance service agreement includes a predetermined date that indicates when terms in said prepaid roadside assistance service agreement expire.

8. The system of claim 1, wherein said prepaid roadside assistance service agreement module determines whether said prepaid roadside assistance service agreement is expired.

9. The system of claim 1, further comprising a purchaser module, said purchaser module including information regarding at least one party that purchases said prepaid roadside assistance service agreement.

10. The system of claim 1, wherein said roadside assistance service includes one of a battery jump-start, a fluid refill, unlocking a door, providing a tow and changing a tire.

11. The system of claim 1, wherein said prepaid roadside assistance service agreement further includes a promise to provide at least one other roadside assistance service.

12. The system of claim 11, wherein said roadside assistance service includes one of a battery jump-start, a fluid refill, unlocking a door, providing a tow and changing a tire.

13. The system of claim 1, wherein said prepaid roadside assistance service agreement further includes a promise to provide at least one roadside assistance service.

14. A method for providing prepaid roadside assistance services, said method comprising:
generating a prepaid roadside assistance service agreement, said prepaid roadside assistance service agreement including a promise to provide one roadside assistance service at a corresponding price;
offering said prepaid roadside assistance service agreement for sale, wherein said cost of said agreement is equal to said corresponding price;
receiving said corresponding price for said prepaid roadside assistance service agreement from a buyer; and
after said corresponding price is received, providing said one roadside assistance service to said buyer.

15. The method of claim 14, wherein said roadside assistance service includes one of a battery jump-start, a fluid refill, unlocking a door, providing a tow and changing a tire.

16. The method of claim 14, further comprising including a predetermined period of time in which said promise is enforceable, and canceling said prepaid roadside assistance service agreement after expiration of said predetermined period of time.

17. The method of claim 16, further comprising offering said prepaid roadside assistance service agreement for sale in a retail store, and measuring said predetermined period time from the date said prepaid roadside assistance service agreement is distributed in said retail store.

18. The method of claim 14, wherein said prepaid roadside assistance service agreement is formatted as a card having a perforated portion.

19. The method of claim 14, wherein said prepaid roadside assistance service agreement includes at least one promise to provide at least one other roadside assistance service at another corresponding price.

20. The method of claim 19, wherein said at least one other roadside assistance service includes at least one of a battery jump-start, a fluid refill, unlocking a door, providing a tow and changing a tire.

21. The method of claim 14, wherein said prepaid roadside assistance service agreement further includes a promise to provide at least one other service not related to roadside assistance.

22. The method of claim 21, wherein said at least one other service includes identifying the location of a disabled vehicle, and providing at least one locating a nearby automatic teller machine, finding a nearby gas station, relaying a message, providing directions, offering rental discounts, providing trip planning, providing accident repair assistance, providing new and used vehicle purchasing services and providing telephone access to a mechanic.

23. The method of claim 14, further comprising identifying at least one subcontractor to provide said one roadside assistance service on said prepaid roadside assistance service agreement.
